(19) United States
(12) Patent Application Publication
(10) Pub. No.: US 2014/0211483 A1
(43) Pub. Date: Jul. 31, 2014

(54) OPTICAL SHEET

(71) Applicant: Su Hyeon Cho, Seoul (KR)

(72) Inventor: Su Hyeon Cho, Seoul (KR)

(73) Assignee: LG INNOTEK CO., LTD., Seoul (KR)

(21) Appl. No.: 14/342,158

(22) PCT Filed: Aug. 31, 2012
(86) PCT No.: PCT/KR2012/007010

§ 371 Date: Feb. 28, 2014

(30) Foreign Application Priority Data
Sep. 2, 2011 (KR) 10-2011-0089068

(51) Int. Cl. G02B 5/02; F21V 11/16

(52) U.S. Cl. CPC G02B 5/0226; F21V 11/16
USPC 362/311.01; 362/355; 428/141

(57) ABSTRACT

Provided is an optical sheet, the optical sheet comprising: a base film; and a plurality of constructions which are irregularly arranged on one surface of the base film so that an arrangement axis of one construction is out of an arrangement axis of another construction adjacent to one side surface of the base film within a range of 1 to 50% of a length or a width of the another construction. Thus, a protective film and a prism type sheet are removed, and the weakness and workability of processes are improved, thereby being capable of reducing a unit price. Furthermore, a shielding force which is the most weakness of the prism type sheet can be improved.

### TECHNICAL FIELD

The present invention relates to an optical sheet.

### BACKGROUND ART

In general, a liquid crystal display device which is one of flat display devices for displaying an image using liquid crystal is thin and light compared to other display devices and has a low consumption electrical power and low driving voltage. Thus, due to these advantages, it has been widely used throughout the industry.

The liquid crystal display device as described above is formed of a liquid crystal display panel for displaying an image and a backlight unit for providing light to the liquid crystal display panel.

The backlight unit includes: a light source which generates light; a light guide plate which changes the path of light incident from the light source and emits the light in a direction of the liquid crystal display panel; and a plurality of optical sheets and a receiving container to improve a luminance characteristic of the light emitted from the light guide plate. Here, the plurality of optical sheets is composed of a diffusion sheets for diffusing the light, a prism sheet for concentrating the light, and the like.

Currently, the display device has the following trends: first, whether or not its slimness can be implemented, second, whether or not energy efficiency can be improved by a low voltage, and third, whether or not it is friendly environmental.

To meet customers' these requirements, the permeability of a panel has been improved, thereby increasing luminance. In addition to this, the application of an LED to the backlight unit has been rapidly increased.

A sheet structure in an LED backlight unit has applied a sheet having high luminance. In this structure, an indispensable optical sheet is a prism sheet. With respect to a structural characteristic, the prism sheet is a sheet which can most efficiently move light up.

FIG. 1 is a view showing the configuration of a conventional backlight unit.

As shown in FIG. 1, the conventional backlight unit is configured such that: a fluorescent lamp 1 which is a linear light source, and a lamp reflective plate 2 which reflects light of the fluorescent lamp 1 are disposed on one side surface of a light guide plate 3 for changing the light from the fluorescent lamp 1 to a surface light source; a reflective sheet 4 for preventing the light from leaking is disposed in a lower part of the light guide 3; a diffusion sheet 5 for uniformly diffusing the light is disposed in an upper part of the light guide plate 3; and thereon prism sheets 6 and 7 having a plurality of linear prisms 8 and 9 in a triangle shape are placed in order to concentrate the scattered light. Two prism sheets 6 and 7 are disposed so that the linear prisms 8 and 9 are perpendicular to each other, and thus each light in different directions is concentrated. Furthermore, on the prism sheet 9 of the upper part, a protective sheet 10 is disposed to prevent faulty such as scratches in a prism shape and foreign substances being embedded. Thus, the backlight unit is produced by assembling each configuration.

However, the conventional prism sheet cannot be independently used due to the high visibility of scratches caused by a low shielding property and the low regularity of mountains. Therefore, the conventional prism sheet should be applied with a diffusion sheet or a composite sheet. To solve this problem, when a prism mold is manufactured, a direction of the mountains may be adjusted through vibrations. Furthermore, to increase the intensity of mountains and protect the mountains, a construction may be arbitrarily inserted. However, even though the prism sheet is manufactured by these various methods, the problems of the prism continue to exist.

That is, a real prism type construction has a high haze characteristic, but it is problematic that since refraction is generated in same directions, the shielding property is deteriorated.

### DISCLOSURE OF INVENTION

### Technical Problem

The present invention has been made keeping in mind the above problems, and an aspect of the present invention provides an optical sheet having the shielding property and scratch resistance of a prism type product.

### Solution to Problem

According to an aspect of the present invention, there is provided an optical sheet including: a base film; and a plurality of constructions which are irregularly arranged on one surface of the base film so that an arrangement axis of one construction is out of an arrangement axis of another construction adjacent to one side surface of the base film within a range of 1 to 50% of a length or a width of the another construction.

The construction may have one shape of prism, lenticular, R-prism, pyramid, and lens shapes.

The construction may have a width and a length decided within a range of 5 to 400 μm.

A length of the construction may be more than the width or length of a cross-section of the construction.

The plurality of constructions may have different shapes from each other.

The constructions having one shape of the prism and R-prism shapes may have an apex angle decided within a range of 50 to 130°.

The optical sheet may be formed on another surface of the base film, and may further include the plurality of constructions having sag decided within a range of 0.01 to 0.3.

The sag may be decided according to desired optical properties of the optical sheet.

The optical sheet may further include glass beads which are applied to another surface of the base film in an area of less than 10% to a total area of the base film.

The constructions may be formed of an acrylic-based curing resin.

An area occupied by the constructions arranged on one surface of the base film may be more than 65% to the total area of the base film.

The base film may be formed of any one of polymethyl methacrylate (PMMA), polyethylen terephthalate (PET) and polycarbonate (PC).

The constructions may have different heights from each other.

### Advantageous Effects of Invention

In accordance with the present invention, a protective film of the prism type sheet can be removed, and the weakness and workability of processes can be improved, thereby being capable of reducing a unit price. Furthermore, the shielding force which is the most weakness of the prism type sheet can be improved.

### BRIEF DESCRIPTION OF DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view showing the configuration of a conventional backlight unit.

FIG. 2 is a perspective view of an optical sheet according to an exemplary embodiment of the present invention.

FIG. 3 through FIG. 6 are perspective views showing an optical sheet according to another exemplary embodiment of the present invention.

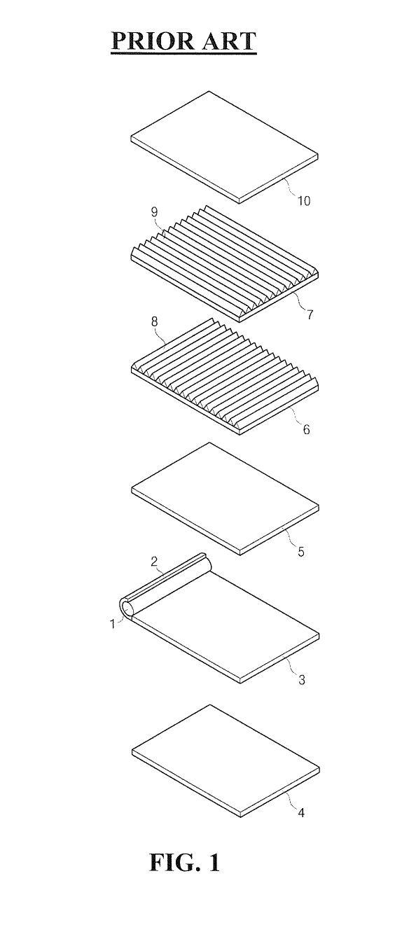

### MODE FOR THE INVENTION

Exemplary embodiments according to the present invention will now be described more fully hereinafter with reference to the accompanying drawings. Meanwhile, when it is determined that specific descriptions regarding publicly known relevant functions or configurations may unnecessarily be beside main points of the present invention, corresponding descriptions are omitted. Furthermore, sizes of each element in the drawings can be exaggerated for the convenience of the descriptions, which does not reflect the actual sizes of the corresponding elements.

The present invention provides an optical sheet having the shielding property and scratch resistance of a prism type product. Specifically, the present invention provides the optical sheet having a plurality of constructions which are randomly arranged is provided.

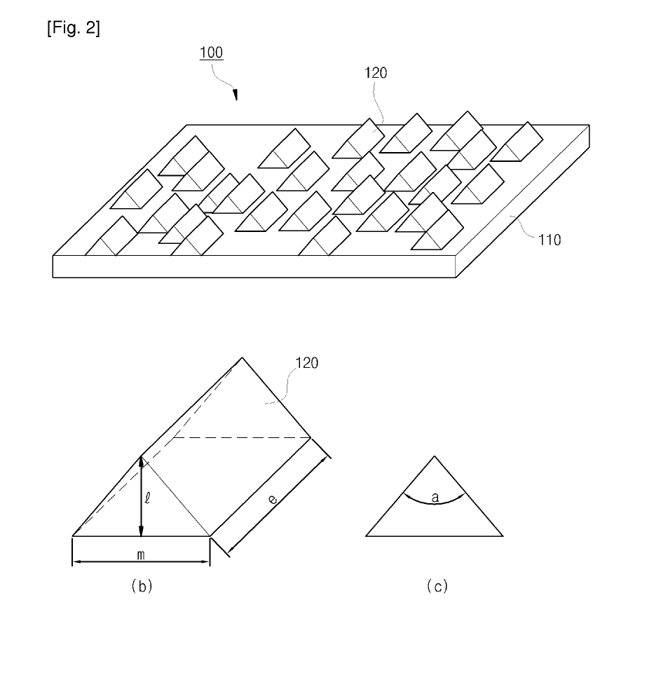

The optical sheet according to an exemplary embodiment of the present invention will be explained with reference to FIG. 2.

FIG. 2 is a perspective view of an optical sheet according to an exemplary embodiment of the present invention.

Referring to FIG. 2, an optical sheet 100 according to an exemplary embodiment of the present invention has a base film 110 and a plurality of constructions 120 which are randomly arranged on the base film 110.

In the present exemplary embodiment, each of the plurality of constructions 120 has a prism shape. Furthermore, the plurality of constructions 120 are irregularly located on the base film 100 so that an arrangement axis of one construction is out of an arrangement axis of another construction adjacent to one side surface of the base film within a range of 1 to 50% of a predetermined area. Here, the arrangement axis means a central axis of the constructions 120 which are parallel to one side surface of the base film 110 on which the constructions 120 are arranged. Furthermore, the predetermined area is decided by a length or a width of each construction. Therefore, a position of the arrangement axis of one construction on the base film 110 may be decided within the range of 1 to 50% of a length or a width of another construction adjacent to one side surface of the base film 110.

In the other words, the plurality of constructions are arranged or located on the base film 110 so that the arrangement axis of one construction is out of the arrangement axis of another construction adjacent to one side surface of the base film within the range of 1 to 50% of the length or width of the another construction. Accordingly, each construction 120 is not arranged in a line with constructions adjacent thereto. That is, the arrangement axis of each construction 120 is not coincident with that of the construction adjacent thereto.

Thus, the plurality of constructions 120 may be irregularly disposed on the base film 110. The constructions 120 have irregular prism type mountains, thereby improving scratch resistance.

In addition, referring to FIG. 2(b), the constructions 120 in a prism shape has a length (e) which is more than a width (m) and a length (l) of its cross-section. The width and length may be decided within a range of 5 to 400 μm. Furthermore, heights of each construction, namely, the lengths (l) may be different from each other. In other words, the constructions 120 may have different heights (l) from each other.

Furthermore, referring to FIG. 2(c), in the constructions in the prism shape, an upper angle, namely, an apex angle may be decided within a range 50 to 130°.

In the optical sheet 100 of the configuration as described above, lights are refracted in different directions from each other, thereby being capable of improving a shielding property. Also, as their regular prism type mountains are provided, the scratch resistance may be improved.

The optical sheet according to the first exemplary embodiment includes prism type constructions, but the present invention is not limited to this.

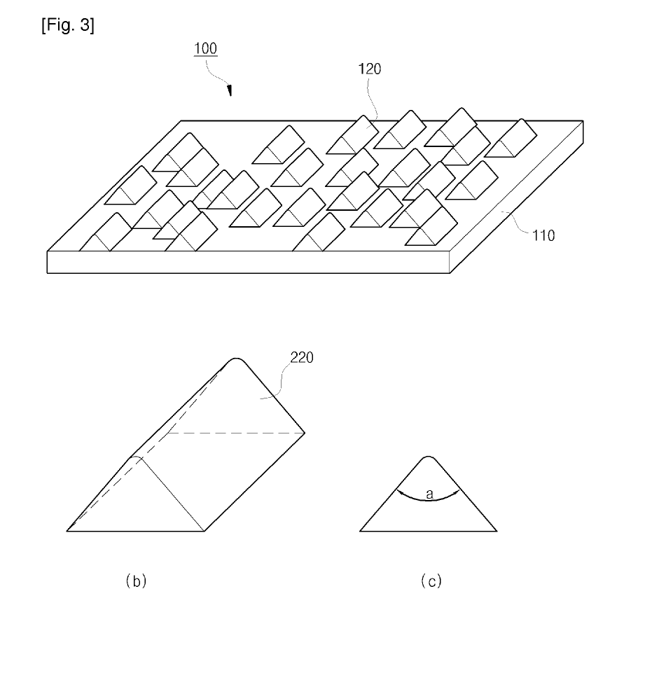

FIG. 3 through FIG. 6 are perspective views showing an optical sheet according to another exemplary embodiment of the present invention.

An optical sheet 200 of FIG. 3 has a base film 210, and a plurality of constructions 220 which are randomly arranged on the base film 210. Here, each construction 220 has an R-prism shape. Referring to FIG. 3(b), one R-prism type construction is illustrated.

The R-prism type construction may also have a structural characteristic of the optical sheet according to the first exemplary embodiment of the present invention as described above. For example, referring to FIG. 3(c), a lenticular type construction has an upper angle, namely, an apex angle, which is decided within the range of 50 to 130°.

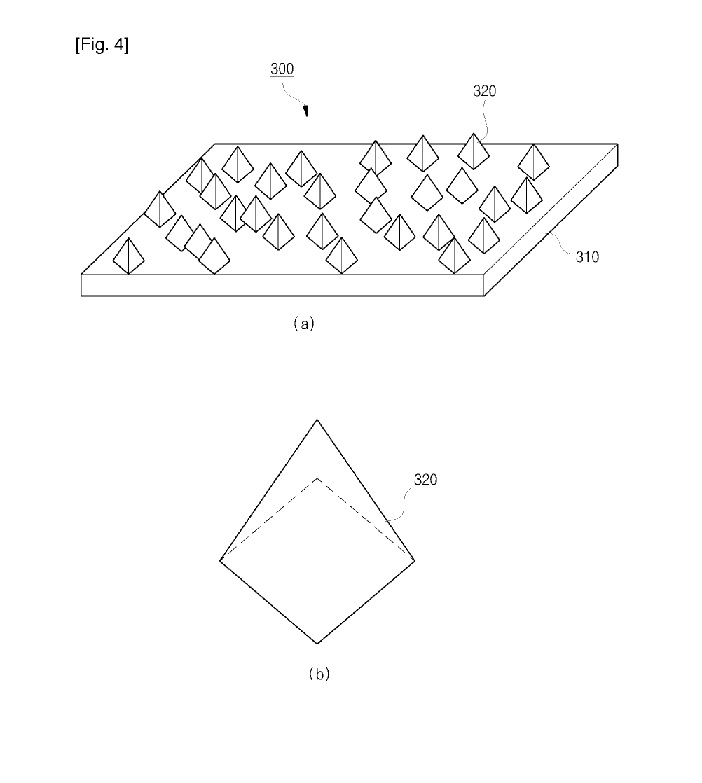

In FIG. 4, an optical sheet 300 includes a base film 310, and a plurality of constructions 320 in a pyramid shape which are irregularly arranged on the base film 310. Referring to FIG. 4(b), one pyramid type construction is illustrated.

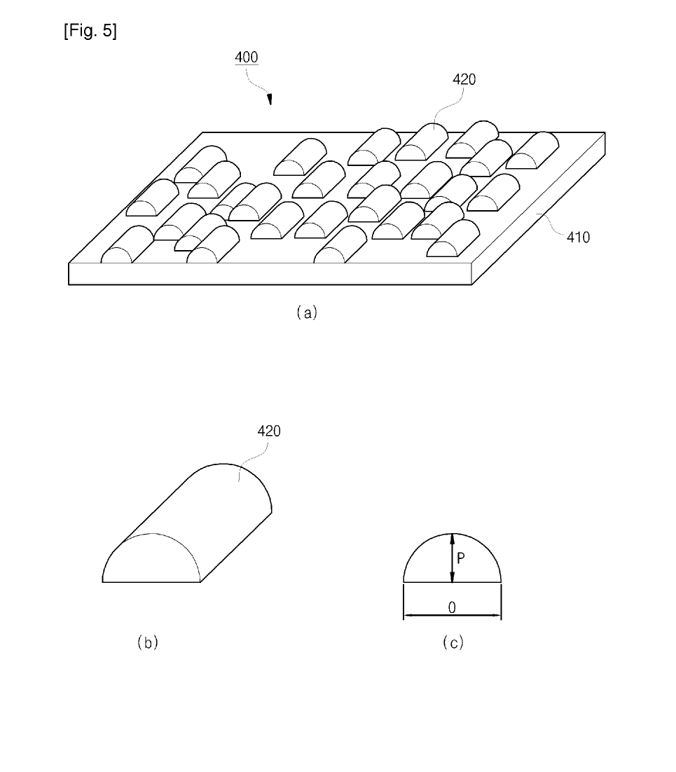

An optical sheet 400 of FIG. 5 has a base film 410, and a plurality of constructions 420 which are randomly arranged on the base film 410. Here, each construction 420 has a lenticular shape. Referring to FIG. 5(b), one lenticular type construction 420 is illustrated.

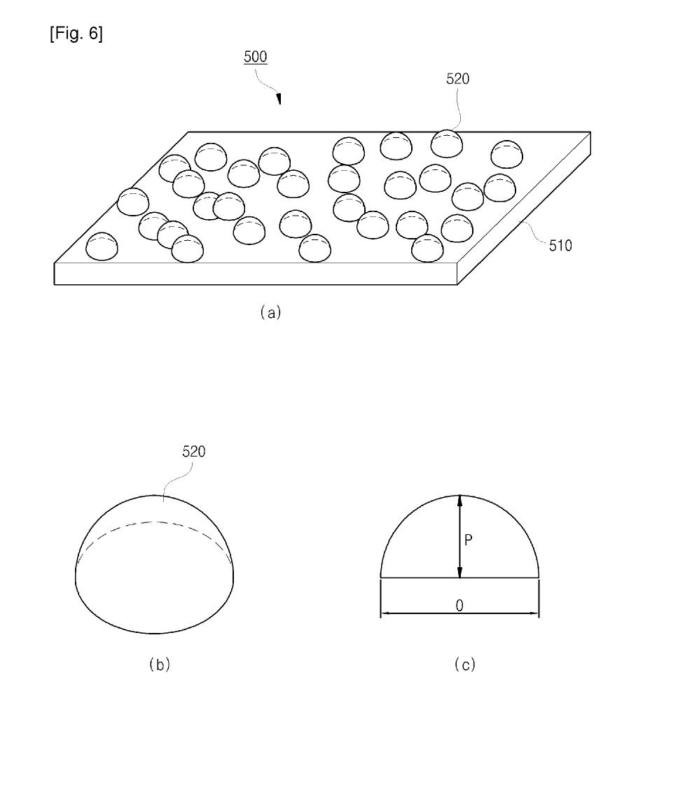

In FIG. 6, an optical sheet 500 has a base film 510, and a plurality of lens type constructions 520 which are randomly arranged on the base film 510.

The lenticular type construction 420 of FIG. 5 and the lens type construction 520 of FIG. 6 all may have a predetermined sag value. As illustrated in FIG. 5(c) and FIG. 6(c), the sag represents a height (P) of the lens to a diameter (O) of the lens. The sag may be expressed as shown in following mathematical formula 1.

[Mathematical Formula 1]

Sag=Height of Lens/Diameter of Lens

The higher the sag of each lens is, the more light is refracted to a direction facing a bottom surface from a ceiling. The sag of the respective constructions 420 and 520 may decide optical properties of the optical sheets 400 and 500. Thus, the sag may be decided according desired optical properties.

The base films 120, 220, 320, 420 and 520 of the above exemplary embodiments may be produced in a sheet shape, and thermoplastic resins having good transmission, and balanced mechanical properties (in particular, impact resistance), heat resistance and electric properties, for example, without any limitation, materials such as polymethyl methacrylate (PMMA), polyethylen terephthalate (PET) or polycarbonate (PC) may be used.

Furthermore, the area occupied by the constructions arranged on the base film may be more than 65% to a total area of the base film. That is, a prism fill factor of the constructions may be more than 65%.

The constructions may be formed of acrylic-based curing resins.

Alternatively, glass beads may be coated with an opposite surface to a surface of the base film, on which the constructions are arranged, in a range of less than 10% of an area.

Furthermore, alternatively, the constructions having sag in a range of 0.01 to 0.3 may be formed on the opposite surface to the surface of the base film on which the constructions are arranged. Thus, the optical properties of a backlight unit in which the optical sheet is used may be improved.

The optical sheets according to the above exemplary embodiments include the constructions in one shape, respectively, but the present invention is not limited to this. According to other exemplary embodiments, the optical sheets may include the constructions having different shapes from each other. For example, the optical sheets may include the prism type constructions and the lenticular type constructions.

By this method, a protective film of the prism type sheet is removed, and the weakness and workability of processes are improved, thereby being capable of reducing a unit price. Furthermore, the shielding force which is the most weakness of the prism type sheet is improved, thereby being capable of replacing the traditional structure of a prism plus a prism plus an MLF (or diffusion sheet) with the structure of an MLF plus a prism.

Because the constructions are randomly arranged on the base film, a factor of deterioration in luminance occurs. However, as shown in Table 1, the reducing ratio of luminance based on a fill factor of the constructions was confirmed by an optical simulation. As a result, when the reducing ratio is more than 65%, the constructions may have a high shielding factor and the reduction factor of a unit price which are compared with the reduction of luminance.

TABLE 1

| Prism Fill Factor (%) | Nit | Rate of Increase |
|---|---|---|
| 66.6 | 3951.6 | 92% |
| 75 | 4038.4 | 94% |
| 100 | 4308.2 | 100% |

The fill factor in above Table 1 means a ratio occupied by the lens (a prism and other lenses) based on a total area of 100. The Nit is the unit of luminance at the time of performing the optical simulation. The brightness of light emitted from a unit area is Nit, namely, luminance.

Furthermore, the rate of increase means the rates of increase and reduction of luminance. In the fill factor of 100, if luminance is 100, the rate of increase shows a change value of the luminance caused by a change of the fill factor. For example, if the rate of increase of luminance is 100% when the fill factor is 100, and if the rate of increase of luminance is 94% when the fill factor is 75, this means that the rate of reduction of luminance compared to the fill factor is low.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

1. An optical sheet, comprising:
a base film; and
a plurality of constructions arranged on one surface of the base film,
wherein the plurality of constructions are arranged so that on the basis of an arrangement axis of constructions adjacent to one side surface of the base film, the arrangement axis is out of an arrangement axis of other constructions.

2. The optical sheet of claim 1, wherein the plurality of constructions are arranged so that on the basis of the arrangement axis of the constructions adjacent to one side surface of the base film, the arrangement axis is out of the arrangement axis of other constructions within a range of 1 to 50% of a length or width of the other constructions.

3. The optical sheet of claim 2, wherein the plurality of constructions different heights.

4. The optical sheet of claim 3, wherein the the plurality of constructions have a length (e) which is more than a horizontal length (m) or a longitudinal length (l) of a vertical section of the plurality of constructions.

5. The optical sheet of claim 4, wherein the horizontal length (m) or the longitudinal length (l) of the vertical section of the plurality of constructions ranges from 5 to 400 μm.

6. The optical sheet of claim 2, wherein the plurality of constructions have different shapes.

7. The optical sheet of claim 2, wherein an area (fill factor) occupied by the plurality of constructions arranged on the one surface of the base film is 65% or more with respect to a total area of the base film.

8. The optical sheet of claim 2, wherein each of the plurality of constructions has one shape of prism, lenticular, R-prism, pyramid, and lens-like shapes.

9. The optical sheet of claim 8, wherein each of the plurality of constructions has an apex angle decided within a range of from 50 to 130°.

10. The optical sheet of claim 2, further comprising a plurality of constructions arranged on the other surface opposite to the one surface of the base film.

11. The optical sheet of claim 10, wherein a sag of each of the plurality of constructions disposed on the other surface ranges from 0.1 to 0.3.

12. The optical sheet of claim 10, wherein each of the plurality of constructions disposed on the other surface is a light diffusion member.

13. The optical sheet of claim 12, wherein the plurality of constructions disposed on the other surface have a structure in which the other surface of the base film is coated with glass beads.

14. The optical sheet of claim 13, wherein the plurality of constructions disposed on the other surface are formed less than 10% of a total area of the other surface of the base film.

15. A lighting device comprising at least one optical sheet of claim 1.
